(19) United States
(12) Patent Application Publication
(10) Pub. No.: US 2021/0374903 A1
(43) Pub. Date: Dec. 2, 2021

(54) METHOD AND SYSTEM FOR IMAGE REGISTRATION USING REGIONAL WARPING

(71) Applicant: QURAM CO., LTD., Yongin-si (KR)

(72) Inventors: Young Cheul WEE, Suwon-si (KR); Jong O KIM, Hwaseong-si (KR); Sung Min LEE, Anyang-si (KR)

(21) Appl. No.: 16/887,483

(22) Filed: May 29, 2020

(51) Int. Cl. G06T 3/00

(52) U.S. Cl. CPC G06T 3/0068; G06T 3/0093

(57) ABSTRACT

An image registration method including regional warping includes the steps of: determining, by an image registration system, a warping region for performing regional warping on a registration image in which a plurality of images is registered; separating, by the image registration system, a warping region image in the determined warping region from the registration image, and warping the separated warping region image using a predetermined method; and combining, by the image registration system, the warped warping region image with the registration image.

### BACKGROUND

### Field

Exemplary implementations of the invention relates generally to an image registration method and a system thereof and more specifically, to a method and system capable of improving registration results by warping a portion in a registration image in which registration target images are registered.

This invention was supported by the Cross-Ministry Giga KOREA Project and granted from the Ministry of Science, ICT and future Planning, Korea.

### Discussion of the Background

Methods of registering two different images are widely known. Image registration may be frequently used when it is desired to generate an image that covers a wide angle of view, such as a panoramic image or a 360-degree image, and according to the recent trend of distributing a large number of mobile devices (e.g., smart phones, etc.), the image registration is more widely used for various image solutions provided by the mobile devices.

An important factor of the image registration is to provide visually natural registration when two different images are registered. Generally, when there is an area in which two different images are overlapped, the two images are registered for the sake of image registration using a transformation relation of feature points commonly existing in the overlapping area, i.e., matching each other.

Meanwhile, although it is general that natural registration is accomplished when two images are registered using the feature points, particularly when a plurality of images are registered (e.g., to generate a 360-degree image), all the registration target images affect each other, and overall registration quality may be lowered severely.

Generally, a method of manually adding a control point and performing re-registration or calibration, or manually performing calibration while changing seam lines is used to solve the problem of lowered registration quality.

However, since the method of adding a control point is a method of generating new transformation information (i.e., a transformation matrix) on the basis of the control point and performing re-registration, when the re-registration is performed through the new transformation information, there is a problem in the case when the portions previously well-registered are skewed.

In addition, in the case of calibration through seam line adjustment, when there is another visually important object on a seam line that is adjusted, in addition to an area or an object for improving registration performance, registration of the corresponding object is rather deteriorated. In addition, the calibration through seam line adjustment has a problem in the case that it is inappropriate to perform the calibration in an area other than a flat region of an image.

The above information disclosed in this Background section is only for understanding of the background of the inventive concepts, and, therefore, it may contain information that does not constitute prior art.

### SUMMARY

Applicant discovered that when a plurality of images are registered, registration target images affect each other, and overall registration quality may be lowered severely.

Image registration systems and methods constructed according to the principles and exemplary implementations of the invention are capable of improving the registration quality by performing regional warping.

According to one aspect of the invention, an image registration method including regional warping, the method includes the steps of: determining, by an image registration system, a warping region for performing regional warping on a registration image in which a plurality of images is registered; separating, by the image registration system, a warping region image in the determined warping region from the registration image, and warping the separated warping region image using a predetermined method; and combining, by the image registration system, the warped warping region image with the registration image.

The step of determining the warping region may include the steps of: determining a pair of feature points, in which an error caused by registration exists, from the registration image; and determining the warping region including the pair of determined feature points such that the warping region has a size proportional to a distance between the pair of feature points.

The step of warping the determined warping region image in the predetermined method may include the steps of: setting a predetermined number or more of fixed points on a periphery of the separated warping region image; and warping the separated warping region image through a warping algorithm using the set number of fixed points and the pair of feature points as an input.

The warping algorithm may be a thin plate spline warping algorithm.

The step of warping the separated warping region image in the predetermined method may include the steps of: separating the warping region image into a first partial warping region image and a second partial warping region image based on a midpoint of the pair of feature points; and acquiring a result of warping the warping region image by combining warping results generated by warping the first partial warping region image and the second partial warping region image.

The step of acquiring the result of warping the warping region image by combining warping results generated by warping the first partial warping region image and the second partial warping region image may include the steps of: warping the first partial warping region image through a warping algorithm using a first feature point, which is included in the first partial warping region image among the pair of feature points included in the first partial warping region image, and the midpoint of the pair of feature points as an input; and warping the second partial warping region image through the warping algorithm using a second feature point, which is included in the second partial warping region image among the pair of feature points included in the second partial warping region image, and the midpoint of the pair of feature points as an input.

The warping of the first partial warping region image and the warping of the second partial warping region image may be performed in opposite directions.

The step of combining, by the image registration system, the warped warping region image with the registration image may include the step of interpolating a predetermined region based on outer lines of the warped warping region image, by the image registration system.

A non-transitory computer-readable medium having stored thereon computer-executable instructions configured to cause a processor to perform operations for performing the image registration method.

According to another aspect of the invention, an image registration system for performing regional warping, the system includes a processor; and a non-transitory storage medium having stored thereon computer-executable instructions, wherein the computer-executable instructions are configured to determine a warping region for performing regional warping on a registration image in which a plurality of images is registered, configured to separate a warping region image in the determined warping region from the registration image, configured to warp the separated warping region image in a predetermined method, and configured to combine the warped warping region image with the registration image.

The computer-executable instructions may be configured to determine a pair of feature points, in which an error caused by registration exists, from the registration image, and may be configured to determine the warping region including the pair of determined feature points such that the warping region has a size proportional to a distance between the pair of feature points.

The computer-executable instructions may be configured to set a predetermined number or more of fixed points on a periphery of the separated warping region image, and may be configured to warp the separated warping region image through a warping algorithm using the set number of fixed points and the pair of feature points as an input.

The computer-executable instructions may be configured to separate the warping region image into a first partial warping region image and a second partial warping region image based on a midpoint of the pair of feature points, and may be configured to acquire a result of warping the warping region image by combining warping results generated by warping the first partial warping region image and the second partial warping region image.

The computer-executable instructions may be configured to warp the first partial warping region image through a warping algorithm using a first feature point, which is included in the first partial warping region image among the pair of feature points included in the first partial warping region image, and the midpoint of the pair of feature points as an input, and may be configured to warp the second partial warping region image through the warping algorithm using a second feature point, which is included in the second partial warping region image among the pair of feature points included in the second partial warping region image, and the midpoint of the pair of feature points as an input.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the inventive concepts.

FIG. 1 is a schematic diagram of an exemplary embodiment of an image registration system for implementing an image registration method using regional warping constructed according to the principles of the invention.

FIG. 2 is a schematic diagram of another exemplary embodiment of an image registration system using regional warping constructed according to the principles of the invention.

FIG. 3 is a flowchart illustrating an image registration method using regional warping according to the principles of the present invention.

FIGS. 4A, 4B, 4C, 5A, 5B, 6A, 6B, and 6C are photographs illustrating examples of images applying an image registration method using regional warping according to the principles of the invention.

### DETAILED DESCRIPTION

In the following description, for the purposes of explanation, numerous specific details are set forth in order to provide a thorough understanding of various exemplary embodiments or implementations of the invention. As used herein “embodiments” and “implementations” are interchangeable words that are non-limiting examples of devices or methods employing one or more of the inventive concepts disclosed herein. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments. Further, various exemplary embodiments may be different, but do not have to be exclusive. For example, specific shapes, configurations, and characteristics of an exemplary embodiment may be used or implemented in another exemplary embodiment without departing from the inventive concepts.

Unless otherwise specified, the illustrated exemplary embodiments are to be understood as providing exemplary features of varying detail of some ways in which the inventive concepts may be implemented in practice. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an exemplary embodiment may be implemented differently, a specific process order may be performed differently from the described order. For example, two consecutively described processes may be performed substantially at the same time or performed in an order opposite to the described order. Also, like reference numerals denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Further, the D1-axis, the D2-axis, and the D3-axis are not limited to three axes of a rectangular coordinate system, such as the x, y, and z-axes, and may be interpreted in a broader sense. For example, the D1-axis, the D2-axis, and the D3-axis may be perpendicular to one another, or may represent different directions that are not perpendicular to one another. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

As customary in the field, some exemplary embodiments are described and illustrated in the accompanying drawings in terms of functional blocks, units, and/or modules. Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (e.g., microcode) to perform various functions discussed herein and may optionally be driven by firmware and/or software. It is also contemplated that each block, unit, and/or module may be implemented by dedicated hardware, or as a combination of dedicated hardware to u) perform some functions and a processor (e.g., one or more programmed microprocessors and associated circuitry) to perform other functions. Also, each block, unit, and/or module of some exemplary embodiments may be physically separated into two or more interacting and discrete blocks, units, and/or modules without departing from the scope of the inventive concepts. Further, the blocks, units, and/or modules of some exemplary embodiments may be physically combined into more complex blocks, units, and/or modules without departing from the scope of the inventive concepts.

In addition, when any one component ‘transmits’ data to another component, it means that the component may directly transmit the data to another component, or may transmit the data to another component through at least still another component. Contrarily, when any one component ‘directly transmits’ data to another component, it means that the data is transmitted from the component to another component without passing through still another component.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

Hereinafter, the present invention will be described in detail by explaining preferred embodiments of the present invention with reference to the accompanying drawings. Like reference numerals presented in each drawing denote like members.

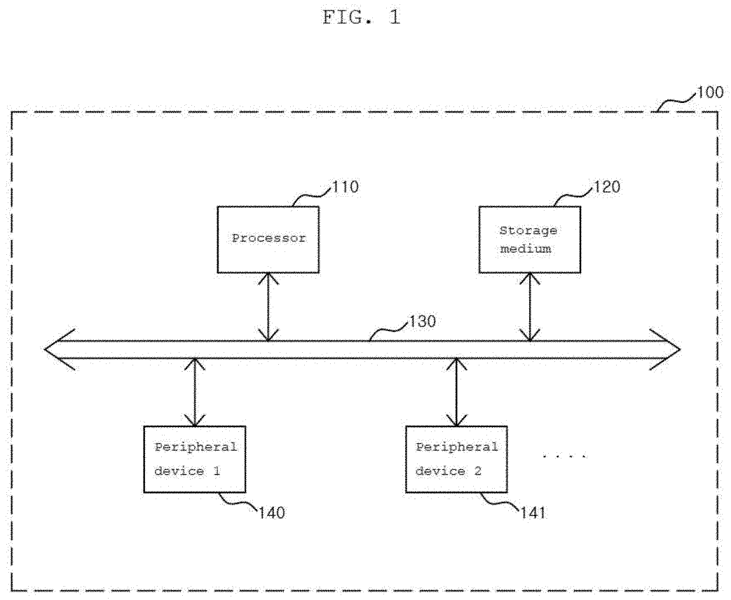

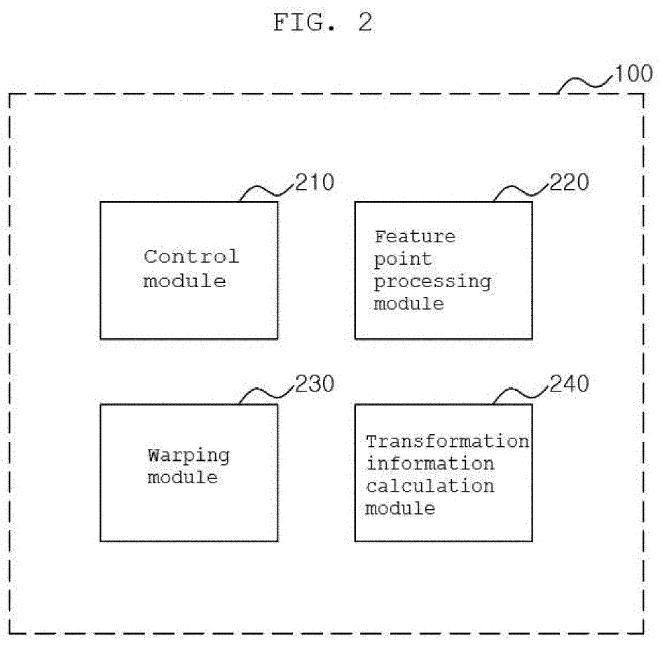

FIG. 1 is a schematic diagram of an exemplary embodiment of an image registration system for implementing an image registration method using regional warping constructed according to the principles of the invention. In addition, FIG. 2 is a schematic diagram of another exemplary embodiment of an image registration system using regional warping constructed according to the principles of the invention.

First, referring to FIG. 1, an image registration system 100 using regional warping according to an exemplary embodiment (hereinafter, referred to as an image registration system) may be implemented as a predetermined data processing device.

As shown in FIG. 1, the image registration system 100 includes a processor 110 and a storage medium 120 for implementing the functions defined in this specification. The processor 110 may include a computing device capable of executing a predetermined program (e.g., software code) such as a data processing device, a vendor mobile processor, a microprocessor, a CPU, a single processor, a multiprocessor, and the like.

The storage medium 120 may include a device in which a program for implementing the exemplary embodiments is stored and installed. According to an exemplary embodiment, the storage medium 120 may be divided into a plurality of different physical devices. According to another exemplary embodiment, a part of the storage medium 120 may exist or embedded inside the processor 110. The storage medium 120 may be implemented as a hard disk, a solid state disk (SSD), an optical disk, a random access memory (RAM), and/or various other types of storage media according to exemplary embodiments. For example, the storage medium 120 may be implemented in the image registration system 100 in a detachable manner.

The image registration system 100 may be a mobile terminal (e.g., a mobile phone, a laptop computer, a tablet computer, etc.), but exemplary embodiments are not limited thereto. For example, the image registration system 100 may also be implemented as any data processing device (e.g., a computer, a server device, etc.) having data processing capability for executing the program.

According to exemplary embodiments, the image registration system 100 may include the processor 110, the storage medium 120, various peripheral devices 141 and 142 (e.g., input/output devices, display devices, audio devices, etc.) provided in the image registration system 100, and a communication interface 130 (e.g., a communication bus, etc.) for connecting these devices.

The exemplary embodiment may be implemented by organically combining the program stored in the storage medium 120 and the processor 110, and the functional configuration unit executed by the image registration system 100 may be implemented as shown in FIG. 2.

Referring to FIG. 2, the image registration system 100 may include a control module 210, a feature point processing module 220, a warping module 230, and a transformation information calculation module 240.

In this specification, a module means a functional and structural combination of hardware for performing the exemplary embodiments (e.g., the processor 110 and/or the storage medium 120) and software for driving the hardware (e.g., the program for implementing the exemplary embodiments). For example, each of the components may include a predetermined code and a logical unit of a hardware resource for executing the predetermined code, but it is not limited to a physically connected code, or a type or a specific number of hardware. For example, each of the components may be a combination of hardware and software performing the functions defined in this specification, and is not limited to a specific physical component.

The control module 210 may control functions and/or resources of other components (e.g., the feature point processing module 220, the warping module 230, and/or the transformation information calculation module 240) included in the image registration system 100.

According to an exemplary embodiment, the control module 210 may transmit and receive signals or information for implementing the exemplary embodiment through communication with a predetermined sensor or control device (e.g., a processor, etc.) installed in the data processing device (e.g., a mobile phone) in which the image registration system 100 is implemented.

For example, the control module 210 may receive information (e.g., camera parameters) on an action performed while the data processing device (e.g., a mobile phone) photographs or takes registration target images. For example, the action may include that the field of view (position or direction) is changed. Alternatively, the action may include that a scale is changed when an image is photographed, and various actions are possible. Information on the actions like this may be used to specify, for example, a registration region or a registration relation of each of the registration target images.

In addition, the control module 210 may combine a warping image with the original image (as described below) after regional warping or local warping is performed.

After combining the warping image at the original position, the control module 210 may perform predetermined interpolation to alleviate unnaturalness of the portions where warping is performed and the portions where warping is not performed, i.e., near the boundary lines of the warping region. When the interpolation is performed, since the boundary lines of the warping region, i.e., the portions near the outer lines of the warped image, are relatively weakly distorted as fixed points are set on the periphery when the warping is performed, there is an effect of more naturally combining an original image and a warped image. Since the interpolation techniques for naturalness are widely and well known, detailed descriptions thereof will be omitted in this specification.

The feature point processing module 220 may extract feature points of objects included in the registration region of each of the registration target images.

The method of extracting the feature points may include various extracting methods. Although the SIFT algorithm may be used, exemplary embodiments are not limited thereto. For example, any method or algorithm may be used as long as peculiar points of objects unrelated to brightness, scale, and/or rotation, i.e., the feature points, can be extracted.

In addition, the feature point process module 220 may determine feature points matching each other among a plurality of feature points extracted from the registration region of each of the registration target images. For example, matching points may be determined among second feature points which are extracted from a second registration region of a second registration target image, and matched to first feature points extracted from a first registration region of a first registration target image, respectively.

According to an exemplary embodiment, the feature point process module 220 may extract a plurality of first feature points from the first registration region. In addition, the feature point process module 220 may extract a plurality of second feature points from the second registration region, and determine feature points respectively matching the first feature points among the extracted second feature points.

The first registration region and/or the second registration region may be the first registration target image and/or the second registration target image themselves. According to an exemplary embodiment, the first registration region and/or the second registration region may be part of the registration target image. Then, the feature point process module 220 may extract feature points from the registration region of each of the registration target images and determine matching feature points.

In addition, the feature point processing module 220 may specify a control point pair for specifying a warping region.

The control point pair may be feature points that match each other. For example, a specific feature point in the first image and a feature point that should match the specific feature point in the second image that will be registered with the first image may be a control point pair.

For example, although the control point pair should be transformed to become points of the exactly same position on the registration image, it may be in a state that does not completely match since there is an error of a predetermined level or higher.

After the image registration is performed, the control point pair may be automatically specified as feature points matching each other and having an error of a predetermined level or higher. According to exemplary embodiments, a control point pair having the largest error within a predetermined region may be automatically extracted.

The predetermined region may be automatically selected by a preset criterion (e.g., a region having high image complexity or a region in which a specific object exists) or may be arbitrarily selected by a user. For example, the user may select a region of interest to increase registration quality, and at least one of the matching feature points existing in the selected region of interest may be specified as a control point pair.

When a control point pair is specified in various ways, the warping module 230 may specify a warping region on the basis of the specified control point pair.

A size of a warping region may be determined based on the specified control point pair. Since the intensity of overall distortion varies after the warping is performed according to the size of a region to be warped, the size of the warping region may need to be set larger than a region that includes the control point pair as a minimum size. For example, when the size of the warping region is set too small, combination of the warping region and the surrounding image after warping may be very unnatural.

Therefore, according to the exemplary embodiments, the warping region may be set to be proportional to the distance between the pair of control points, i.e., the size of the warping distance. For example, the X-axis component of a line segment connecting a pair of control points may be scaled by a predetermined ratio and the Y-axis component may be scaled by a predetermined ratio to specify a warping region. Further, to specify the warping region, a condition that each component of the X-axis and the Y-axis may have a minimum size may be further given. Thus, although the X-axis component or Y-axis component of the line segment connecting the pair of control points does not exist or is very small, the warping region may be set to have a certain length for each component. In any case, the size of the warping region may be variously set to be proportional to the size of the warping distance.

When the warping region is specified as described above, the warping module 230 separates (e.g., crops) the warping region from the original registration image, and may perform transformation on the warping region, i.e., image warping, to be independent from the transformation of each of the images included in the registration image.

The warping module 230 may perform the image warping to move any one control point included in the control point pair to another control point.

At this time, to prevent the boundary line of the warping region from being distorted through the image warping, the warping module 230 sets a predetermined number of fixed points on the boundary lines of the warping region, and the image warping may be performed so that any one control point can be moved to another control point without moving the fixed points.

Then, the warping module 230 may warp the image corresponding to the warping region through a predetermined warping algorithm using the fixed points and a feature point pair, i.e., the control point pair.

According to an exemplary embodiment, the warping module 230 may perform image warping using a thin plate spline warping algorithm. The thin plate spline warping algorithm may find a minimally deformed smooth curved surface that passes all the coordinate values given on a plane. Thus, the warping module 230 may warp the image of the warping region by performing the thin plate spline warping algorithm using the coordinates of the control point pair and the fixed points as an input value through the thin plate spline warping algorithm.

The thin plate spline warping algorithm, which the warping module 230 uses to perform the image warping, is an example, but exemplary embodiments are not limited thereto. For example, various warping methods that do not move the boundary lines of the warping region while matching the control point pair in various ways may be used other than this.

Although the warping module 230 may perform one-time warping for simply matching a control point pair as described above, split warping may be performed according to exemplary embodiments.

For example, a control point pair having a high error rate cannot but have a large warping distance, and when regional warping is performed, the image of warping region may be distorted much as the image on one side is warped in one direction. In this case, although the error may be lowered to zero or close to zero, it may be seen visually awkward. The warping distance must be reduced to prevent excessive distortion of the image, and to this end, the warping module 230 may perform split warping.

For example, the warping module 230 may split an image (e.g., through a straight line orthogonal to a line segment connecting the pair of control points while passing through the midpoint of the line segment) on the basis of the midpoint of the pair of control points (e.g., the midpoint of a line segment connecting the pair of control points).

When warping is performed for each of the split images, the warping distance at the time of each warping may be reduced by half.

For example, after setting each of the pair of control points as a source point in a corresponding image, and setting the midpoint of the pair of control points as a destination point, warping may be performed for each of the split images. For example, the split images may be warped in opposite directions. In this case, since each of the split images is warped in a different direction, there is also an effect of reducing image distortion.

Further, at this point, a fixed point included in the corresponding region among the fixed points set in the entire warping region may be inputted together into the warping algorithm as an input value, and regional warping may be performed for each of the split images.

In addition, in this case, since the warping algorithm has a characteristic of exponentially increasing the execution time as the warping distance increases, it may be much more effective to reduce the warping distance by half and double the number of times of execution, and the distortion degree of each image is also reduced as the warping distance is reduced.

Further, after warping is performed for each of the split images, a warping image for the entire warping region may be acquired by combining the partial images on which warping is performed.

Then, the control module 210 may combine the acquired warping image back into the registration image. At this point, the control module 210 may perform interpolation on a predetermined region near a boundary line of the warping region so that a natural combination of the warping image and the other parts may be achieved.

Further, when regional warping is performed for any one control point pair and a warping image on which the regional warping is performed is combined with a registration image, regional warping may be additionally performed for another control point pair.

For example, the transformation information calculation module 240 may calculate transformation information (e.g., a transformation matrix) for a plurality of images inputted into the image registration system 100. The control module 210 may generate a registration image on the basis of the calculated transformation information.

Reference feature points may need to be selected for the transformation information calculation module 240 to calculate transformation information for each image. The reference feature points may be feature point pairs that serve as a reference for calculating transformation information, among the feature points extracted by the feature point processing module 220. For example, transformation information may be calculated by selecting three feature point pairs as the reference feature points.

The transformation information calculation module 240 may select the reference feature points using a predetermined method including, e.g., the Random Sample Consensus (RANSAC) algorithm.

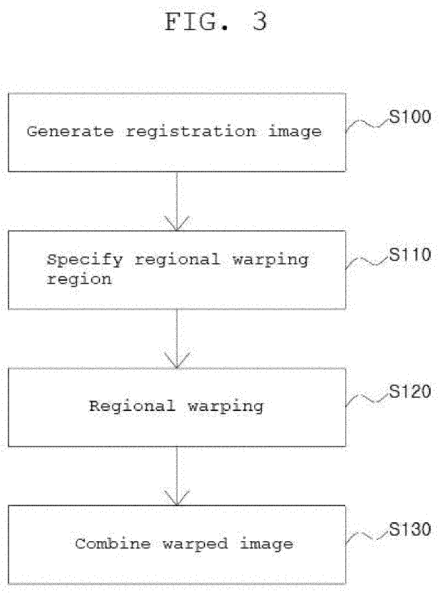

FIG. 3 is a flowchart illustrating an image registration method using regional warping according to the principles of the present invention.

Referring to FIG. 3, when a plurality of registration target images is received, the image registration system 100 may generate a registration image in the step S100.

Then, the image registration system 100 may specify a warping region in which regional warping is to be performed in the step S110.

The warping region may be automatically selected by the image registration system 100 (i.e., a control point pair may be automatically selected) on the basis of predetermined criteria as described above, or may be specified by a user's selection.

To this end, the image registration system 100 may provide a primarily generated registration image to the user, and may receive selection of a user's region of interest on the basis of the provided image. For example, the user may select a region in which registration is desired to be done particularly well. Then, a control point pair may be specified in the selected region. When a control point pair is specified, a warping region may be specified. Further, the user's region of interest and the warping region may be different from each other.

When a warping region is specified, the image registration system 100 may perform regional warping for the warping region image as described above in the step S120.

Then, a regional warping process corresponding to any one control point pair may be completed by combining the performed warping image with the registration image in the step S130.

Further, the regional warping process may be repeated multiple times as needed.

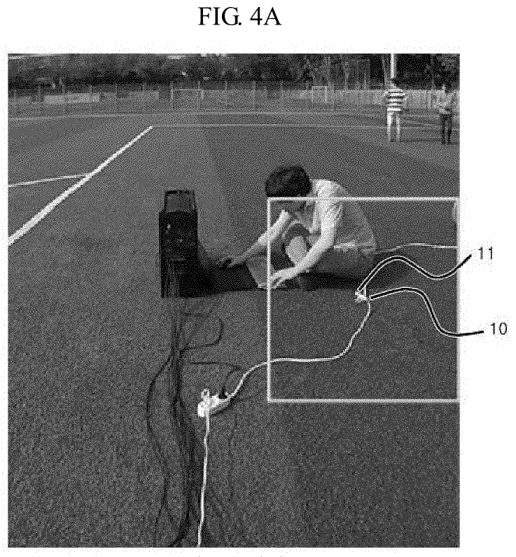

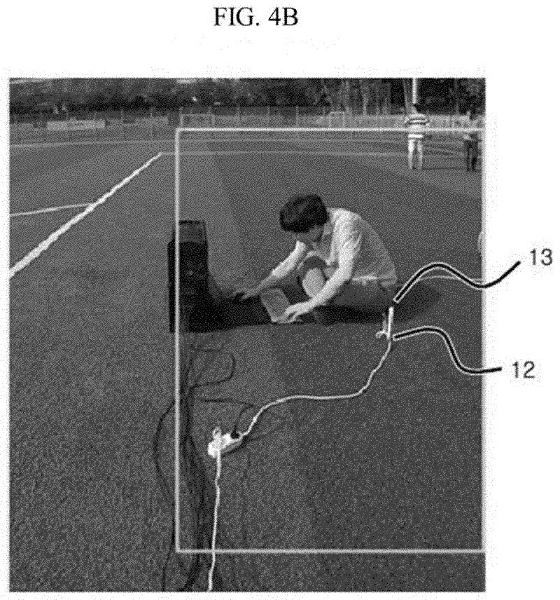

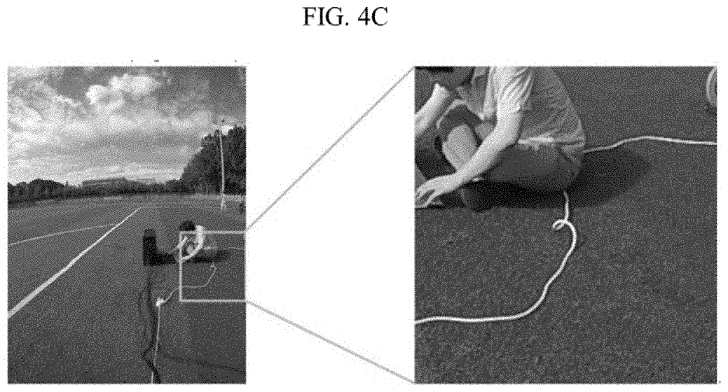

FIGS. 4A, 4B, 4C, 5A, 5B, 6A, 6B, and 6C are photographs illustrating examples of images applying an image registration method using regional warping according to the principles of the invention.

FIG. 4A exemplarily shows a pair of control points 10 and 11 in the image and a warping region (e.g., the area within the rectangle) at this point, and FIG. 4B exemplarily shows another pair of control points 12 and 13 in the image and a corresponding warping region (e.g., the area within the rectangle).

As shown in FIGS. 4A and 4B, the size of the warping region may be set to be proportional to the distance of a pair of control points. For example, as the distance of the pair of control points is decreased, the size of the warping region may be decreased. Further, as the distance of the pair of control points is increased, the size of the warping region may be increased.

When a warping region is specified in this manner to correspond to a pair of control points, the warping region may be separated from the registration image. Then, a warping region image may be acquired as shown in FIG. 4C.

When a warping region image is acquired, the image registration system 100 may set a predetermined number of fixed points on the boundary lines of the warping region (or the outer lines of the warping region image) as described above.

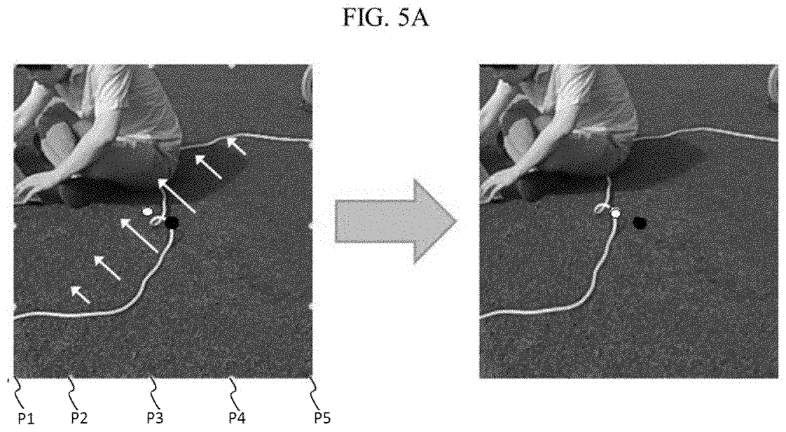

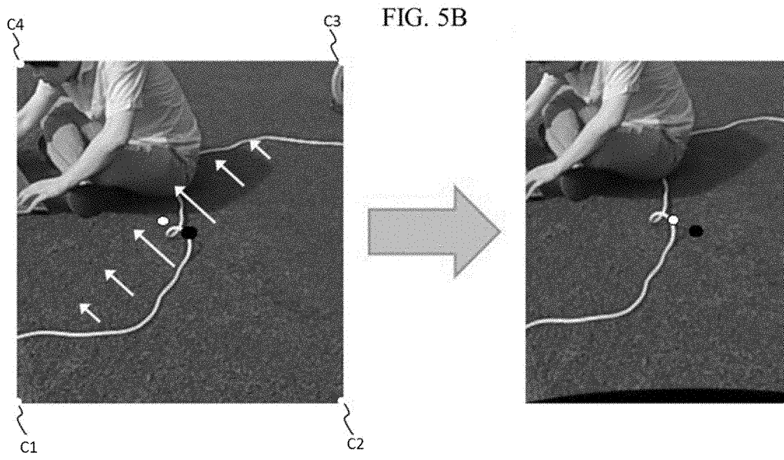

FIG. 5A shows a case of setting five fixed points (e.g., points P1, P2, P3, P4, and P5) for each boundary line of the warping region, and FIG. 5B shows a case where fixed points (e.g., points C1, C2, C3, and C4) are set at only four corners.

Then, the results of warping using these fixed points and the first points (e.g., black dot) as source points and the second points (e.g., white dot) as a destination point are shown on the right sides of FIGS. 5A and 5B, respectively.

FIG. 5B illustrates a case where movement is performed up to the boundary lines of the warping region image as the number of fixed points is insufficient. When the number of fixed points is great, warping efficiency may be lowered, and when the number of fixed points is small, boundary lines may be moved as shown in FIG. 5B, and thus it needs to set an appropriate number of fixed points. Setting of the number of fixed points like this may be selected based on experimental results, or an optimal number of fixed points may be calculated while repeatedly performing the image warping, and various embodiments may be implemented.

In addition, as the warping strength increases near the source point and the destination point and the warping strength decreases as the distance increases by setting the fixed point like this, there is an effect of naturally combining the warped warping region image with the original image, i.e., the registration image.

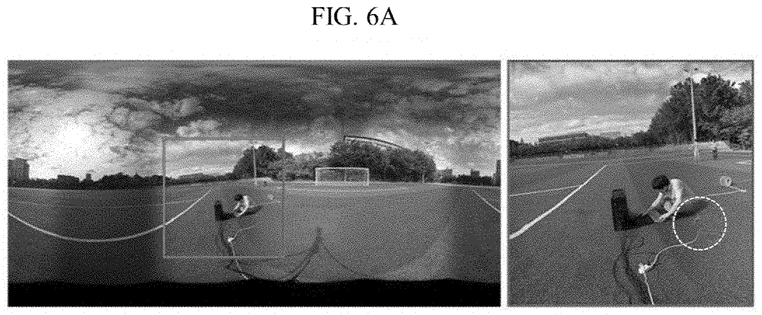

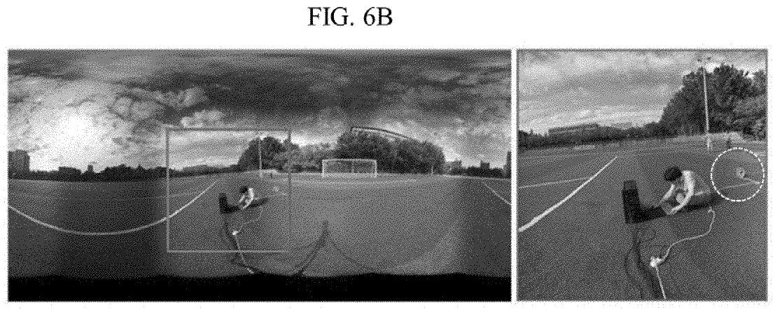

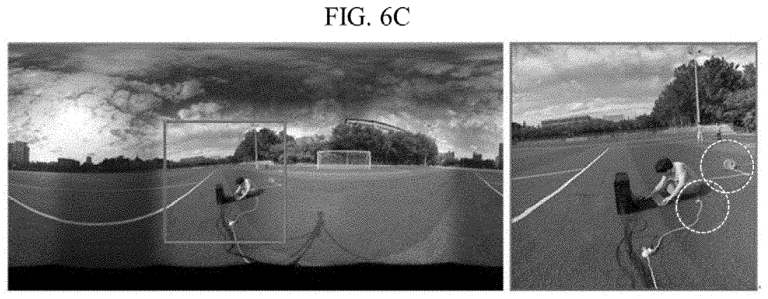

FIG. 6A shows a result (the image on the right side) of performing calibration when a conventional method of manually adding a control point is performed on the basis of a distant object for the image inside the square on the left side. In this case, there may be a problem of lowering the registration quality in the close region (the circle on the right side).

FIG. 6B shows a result (the image on the right side) of performing calibration in a conventional seam adjustment method on the basis of a portion near the image inside the square on the left side. In this case, there may be a problem of lowering the registration quality in a distant area (the circle on the right side).

In addition, FIG. 6C shows a result of performing calibration in the image registration method using regional warping according to the exemplary embodiment, and each of the regions in which the registration quality is lowered in FIGS. 6A and 6B may have relatively excellent registration quality.

As a result, according to the exemplary embodiments, as intensive calibration may be performed on a specific region to be independent from the transformation of each of the registration target images, it is possible to improve the problem of lowering the registration quality of another region, i.e., a region in which the registration quality is relatively good, to increase the registration quality of any one region.

The image registration method using regional warping according to an exemplary embodiment may be implemented as a computer-readable code in a computer-readable recording medium. The computer-readable recording medium includes all kinds of recording devices in which data that can be read by a computer system is stored. Examples of the computer-readable recording medium are ROM, RAM, CD-ROM, a magnetic tape, a hard disk, a floppy disk, an optical data storage device and the like. In addition, the computer-readable recording medium may be distributed in computer systems connected through a network, and a code that can be read by a computer in a distributed manner may be stored and executed therein. In addition, functional programs, codes and code segments for implementing the present invention may be easily inferred by the programmers in the art.

Since transformation of each image for conventional image registration is achieved by one transformation formula, it is difficult to fundamentally improve the registration quality by recalculating or modifying the transformation formula, whereas according to the exemplary embodiments, there is an effect of acquiring a registration quality higher than that of a conventional method at least in some corresponding regions, by performing transformation in a method independent from transformation of an image only in some regions where the registration quality is desired to be improved, i.e., performing regional warping.

Particularly, as regional warping (local warping) independent from transformation of the entire image is performed to eliminate or extremely lower the error between two points that are not registered well due to a large error, the registration quality can be improved greatly for a corresponding region, and there is an effect of solving the problem that the conventional method has.

Although certain exemplary embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

What is claimed is:

1. An image registration method including regional warping, the method comprising the steps of:
determining, by an image registration system, a warping region for performing regional warping on a registration image in which a plurality of images is registered;
separating, by the image registration system, a warping region image in the determined warping region from the registration image, and warping the separated warping region image using a predetermined method; and
combining, by the image registration system, the warped warping region image with the registration image.

2. The method of claim 1, wherein the step of determining the warping region comprise the steps of:
determining a pair of feature points, in which an error caused by registration exists, from the registration image; and
determining the warping region including the pair of determined feature points such that the warping region has a size proportional to a distance between the pair of feature points.

3. The method of claim 2, wherein the step of warping the separated warping region image in the predetermined method comprises the steps of:
setting a predetermined number or more of fixed points on a periphery of the separated warping region image; and
warping the separated warping region image through a warping algorithm using the set number of fixed points and the pair of feature points as an input.

4. The method of claim 3, wherein the warping algorithm is a thin plate spline warping algorithm.

5. The method of claim 2, wherein the step of warping the separated warping region image in the predetermined method comprises the steps of:
separating the warping region image into a first partial warping region image and a second partial warping region image based on a midpoint of the pair of feature points; and
acquiring a result of warping the warping region image by combining warping results generated by warping the first partial warping region image and the second partial warping region image.

6. The method of claim 5, wherein the step of acquiring the result of warping the warping region image by combining warping results generated by warping the first partial warping region image and the second partial warping region image comprises the steps of:
warping the first partial warping region image through a warping algorithm using a first feature point, which is included in the first partial warping region image among the pair of feature points included in the first partial warping region image, and the midpoint of the pair of feature points as an input; and
warping the second partial warping region image through the warping algorithm using a second feature point, which is included in the second partial warping region image among the pair of feature points included in the second partial warping region image, and the midpoint of the pair of feature points as an input.

7. The method of claim 6, wherein the warping of the first partial warping region image and the warping of the second partial warping region image are performed in opposite directions.

8. The method of claim 1, wherein the step of combining, by the image registration system, the warped warping region image with the registration image comprises the step of interpolating a predetermined region based on outer lines of the warped warping region image, by the image registration system.

9. A non-transitory computer-readable medium having stored thereon computer-executable instructions configured to cause a processor to perform operations for performing the method of claim 1.

10. An image registration system for performing regional warping, the system comprising:
a processor; and
a non-transitory storage medium having stored thereon computer-executable instructions, wherein
the computer-executable instructions are configured to determine a warping region for performing regional warping on a registration image in which a plurality of images is registered, configured to separate a warping region image in the determined warping region from the registration image, configured to warp the separated warping region image in a predetermined method, and configured to combine the warped warping region image with the registration image.

11. The system of claim 10, wherein the computer-executable instructions are configured to determine a pair of feature points, in which an error caused by registration exists, from the registration image, and configured to determine the warping region including the pair of determined feature points such that the warping region has a size proportional to a distance between the pair of feature points.

12. The system of claim 11, wherein the computer-executable instructions are configured to set a predetermined number or more of fixed points on a periphery of the separated warping region image, and configured to warp the separated warping region image through a warping algorithm using the set number of fixed points and the pair of feature points as an input.

13. The system of claim 11, wherein the computer-executable instructions are configured to separate the warping region image into a first partial warping region image and a second partial warping region image based on a midpoint of the pair of feature points, and configured to acquire a result of warping the warping region image by combining warping results generated by warping the first partial warping region image and the second partial warping region image.

14. The system of claim 13, wherein the computer-executable instructions are configured to warp the first partial warping region image through a warping algorithm using a first feature point, which is included in the first partial warping region image among the pair of feature points included in the first partial warping region image, and the midpoint of the pair of feature points as an input, and configured to warp the second partial warping region image through the warping algorithm using a second feature point, which is included in the second partial warping region image among the pair of feature points included in the second partial warping region image, and the midpoint of the pair of feature points as an input.
